(19) United States
(12) Patent Application Publication
(10) Pub. No.: US 2025/0381730 A1
(43) Pub. Date: Dec. 18, 2025

(54) LITHOGRAPHY PRODUCT AND METHOD FACILITATED BY ONE OR MORE AVALANCHING NANOPARTICLES

(71) Applicant: THE TRUSTEES OF COLUMBIA UNIVERSITY IN THE CITY OF NEW YORK, New York, NY (US)

(72) Inventors: Peter James SCHUCK, New York, NY (US); Emma Zeyan XU, New York, NY (US)

(73) Assignee: THE TRUSTEES OF COLUMBIA UNIVERSITY IN THE CITY OF NEW YORK, New York, NY (US)

(21) Appl. No.: 19/279,838

(22) Filed: Jul. 24, 2025

Related U.S. Application Data
(63) Continuation of application No. PCT/US2024/013371, filed on Jan. 29, 2024.
(60) Provisional application No. 63/441,517, filed on Jan. 27, 2023.

(51) Int. Cl. B29C 64/135; B29C 64/268; B29K 63/00; B33Y 10/00; B33Y 30/00; B33Y 70/10; C09D 7/40; C09D 163/00

(52) U.S. Cl. CPC B29C 64/135; B29C 64/268; B33Y 10/00; B33Y 30/00; B33Y 70/10; C09D 7/67; C09D 163/00; B29K 2063/00

(57) ABSTRACT

According to exemplary embodiments of the present disclosure, products and methods can be provided for 3D printing on the nanoscale with avalanching nanoparticles. For example, polymerizable photoactivated material can be provided into which one or more avalanching nanoparticles can be embedded. With exemplary methods, it is possible to directs a radiation from a continuous wave infrared laser to impact and activate one or more ANPs embedded in the polymerizable photoactivated material.

### CROSS REFERENCE TO RELATED APPLICATION(S)

This application relates to and claims the benefit of priority from U.S. Provisional Patent Application No. 63/441,517, filed on Jan. 27, 2023, the entire disclosure of which is incorporated herein by reference.

### STATEMENT REGARDING FEDERALLY FUNDED RESEARCH

This invention was made with government support under 2203510 awarded by the National Science Foundation. The government has certain rights in the invention.

### FIELD OF THE DISCLOSURE

The present disclosure relates generally to there-dimensional (3D) printing and more specifically, to use of avalanching nanoparticles in 3-D printing to achieve greater resolution.

### BACKGROUND INFORMATION

Additive manufacturing, or three-dimensional (3D) printing, is a rapid prototyping technique, which first emerged in the 1980s. [See, e.g., Ref. 1] In the late 90s, a method called 2-photon polymerization (TPP) lithography was developed, which pushed the resolution of 3D printing from 50 um with a direct UV light polymerization, down to 100 nm. However, 20+ years and multiple commercialized printer companies later, the 100 nm resolution limit has not yet been achieved. Since then, the global market for 3D printing has reached more than about $14 billion in year 2020, with an annual growth rate of about 22%. The technology utilizes a laser, a scanning mirror, a stage, and photo resin, and it is possible—using a 3D printer—to print and build any arbitrary 3D shape by feeding a CAD design into the printer.

There are various advantages to using additive manufacturing compared to traditional manufacturing methods: In particular, such additive manufacturing can:
eliminate time-consuming toolmaking and fabrication operations, e.g., by accelerating both product development and production, reducing time to market;
be beneficial for industries where function is more important than price, or where small lot sizes or customization make it less expensive to manufacture an object additively than traditionally; and
facilitates the combination of multiple features into a single component, which can reduce the overall number of parts in an assembly, thus reducing and/or eliminating the need for subsequent fabrication or processing steps.

During about the same time when 3D printing matured as a technology and as a global market, there was a movement in the direction of making smaller and smaller devices. For example, micro-scale semiconductors facilitate electronic devices to fit into pockets and onto our wrists. For example, in year 2007, Nanoscribe GmbH provided a traditional macroscopic 3D printing technology down to the microscale, facilitating researchers and technologists to print any arbitrary design with resolutions down to the micron scale or even hundreds of nanometers. [See, e.g., Ref. 2].

Currently, two-photon polymerization (TPP) processing procedures can be utilized as techniques used for high-resolution 3D printing of microscopic objects, typically with a resolution of about 100 nm-10 μm, depending on the setup configuration and the application. TPP is a nonlinear optical process where two photons are absorbed to create an photon at a higher energy at the focal point of the laser.

Compared to a linear optical process where the resolution of the printed structure is limited by the diffraction limit of light, TPP can significantly enhance the achievable printing resolution, to facilitate for more intricately printed objects. This technology has applications mostly in, e.g., the R&D sector, including manufacturing microneedles for drug delivery, mimicking 3D cell culture environments, micro-optics, metamaterials, microfluidics, MEMS, and integrated photonics. However, the freedom to print any structure at the microscale comes with a hefty price tag: most of these printers are sold for at least $600 k and can reach above $1 million, depending on specific features. One of the components that drives up the price is the laser they have to use. To initiate the two-photon process, they need to use a high power femtosecond pulsed laser, which is about 100 times more expensive than a regular continuous wave laser.

While the resolution of TPP is generally above 100 nm, there is a wealth of techniques that facilitate nanoscale manufacturing, with resolutions all the way down to <10 nm. The caveat, though, is that they are orders of magnitude more labor, cost, and time intensive than 3D printing. To fabricate a nanoscale device in the cleanroom, there are usually hundreds of steps involved, it takes several specially trained cleanroom technicians to attend to them around the clock for several days.

A number of instruments are used for such procedures (e.g., evaporators, polishers, etchers, characterization tools etc.), and most are very expensive pieces of equipment.

Indeed, 3D printing has become a rapid prototyping technology for custom-shaped devices without traditional machine tools. With electronic and photonic devices becoming ever smaller, following Moore's Law, innovation in 3D printing is needed to catch up with the demand. Thus, there is a need to address and/or improve such issues and/or deficiencies which exist in the previous technologies and methods.

### SUMMARY OF EXEMPLARY EMBODIMENTS

Such deficiencies can be addressed with lithography (e.g., multiphoton) products and methods facilitated by avalanching nanoparticles, according to exemplary embodiments of the present disclosure. In one non-limiting example, the exemplary embodiments of the present disclosure can fill in the market gap for cost effective, nanoscale manufacturing with resolution between, e.g., about 10 and 100 nm.

The exemplary embodiments of the present disclosure can be facilitated using photon avalanching nanoparticles (ANPs), e.g., as described in U.S. Patent Publication No. 2022/0163384, published on Mar. 26, 2022, the entire disclosure of which is incorporated herein by reference. Due to APNs' high optical nonlinearity, instead of two photon absorption, ANPs can sequentially absorb dozens of near-infrared, and then emit at UV wavelengths. For this exemplary application, ANPs can emit light at the blue/UVA part of the spectrum, thus enhancing the resolution of the final print compared to TPP due to the nanoscale nature of the UV generation. Thus, according to the exemplary embodiments of the present disclosure, such multiphoton polymerization process can be utilized beyond two photon, which is certainly beneficial.

The following is intended to be a brief summary of the exemplary embodiments of the present disclosure, and is not intended to limit the scope of the exemplary embodiments.

In particular, according to some exemplary embodiments of the present disclosure, exemplary products and methods for facilitating 3D printing can be provided which can utilize a polymerizable photoactivated material that includes one or more embedded avalanching nanoparticles (ANPs). The polymerizable photoactivated material can be provided by, e.g., mixing a solvent with a plurality of ANPs.

In some exemplary embodiments of the present disclosure, the exemplary polymerizable photoactivated material can be or include a resin and/or an epoxy, and in either case, can be mixes with one or more ANPs via a liquid such as a gel and/or a solution. In some exemplary embodiments, the density of the one or more ANPs embedded in the polymerizable photoactivated material can comprise a range from virtually or essentially no space between adjacent ANPs to about 100 microns between adjacent ANPs. Further, the polymerizable photoactivated material can be configured to cure a printed structure by the ultraviolet light emitted from the one or more ANPs.

In some exemplary embodiments of the present disclosure, exemplary products and methods for 3D printing can be provided which can include, e.g., directing a radiation from a continuous wave infrared laser to impact and activate one or more ANPs embedded in a polymerizable photoactivated material. According to certain exemplary embodiments of the present disclosure, the radiation be provided to a stage, and may be located on that stage in nanoscale precision. Further, the nanoscale precision may be less than 100 nm, and may be as small as 50 mn.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIG. 1 is an illustration of a multiphoton lithography system facilitated by avalanching nanoparticles according to an exemplary embodiment of the present disclosure.

FIG. 2 is an illustration of the multiphoton lithography system facilitated by the avalanching nanoparticles according to an exemplary embodiment of the present disclosure; and

FIG. 3 is an exemplary graph showing emission in an ultra-violet (UV) part of the spectrum by ANPs when excited by an infrared (IR) laser configuration (e.g., source) according to an exemplary embodiment of the present disclosure.

Throughout the drawings, the same reference numerals and characters, unless otherwise stated, are used to denote like features, elements, components or portions of the illustrated embodiments. Moreover, while the present disclosure will now be described in detail with reference to the figures, it is done so in connection with the illustrative embodiments and is not limited by the certain exemplary embodiments illustrated in the figures and the appended claims.

### DETAILED DESCRIPTION OF EXEMPLARY EMBODIMENTS

The following description of exemplary embodiments provides non-limiting representative examples referencing numerals to particularly describe features and teachings of different aspects of the present disclosure. The exemplary embodiments described should be recognized as capable of implementation separately, or in combination, with other exemplary embodiments from the description of the exemplary embodiments. A person of ordinary skill in the art reviewing the description of the exemplary embodiments should be able to learn and understand the different described aspects of the present disclosure. The description of the exemplary embodiments should facilitate understanding of the invention to such an extent that other implementations, not specifically covered but within the knowledge of a person of skill in the art having read the description of embodiments, would be understood to be consistent with an application of the exemplary embodiments of the present disclosure.

Exemplary products and methods of exemplary embodiments of the present disclosure can provide currently one of highest-resolution 3D printers.

Exemplary embodiments of the present disclosure can use and implement avalanching nanoparticles (ANPs). ANPs are ceramic nanoparticles doped with lanthanide ions to reach a resolution down to 50 nm. Similar to an avalanching process that occurs in nature, once ANPs according to the exemplary embodiments of the present disclosure are excited beyond a threshold, a small change in input can cause the number of output photons to change exponentially. One example of the photon avalanching (PA) is lasing. Another characteristic of ANPs is that they can absorb infrared (IR) light, which can then be upconverted and emitted in the visible and UV part of the spectrum.

Traditional TPP products operate by having, e.g., a high-power, femtosecond 780 nm laser scan over a desired 3D design inside a photoresin. The scanned area hardens with polymerization, and the unscanned resin can be washed away by a developer, leaving the physical rendering of the 3D CAD design as a final product. According to exemplary embodiments of the present disclosure, ANPs can be embedded in the photoresin, and then the same design can be scanned with, e.g., a 1064 nm laser which provides IR radiation. Because the IR to UV upconversion is a multiphoton process, the light can be focused to a significantly tighter spot than a traditional 2-photon process thus polymerizing only a fraction of voxel size compared to TPP.

Moreover, according to the exemplary embodiments of the present disclosure, because the lanthanide ions have real states in the 4P orbital, the ions can sequentially absorb energy and be promoted into higher energy states with long lifetimes. In contrast, TPP requires a high laser power to simultaneously absorb two 780 nm photons to create one 380 nm photon, exemplary products and methods of the present disclosure can be powered by a less expensive (e.g., 2 orders of magnitude less) continuous wave laser as compared to ones needed for TPP.

According to various exemplary embodiments of the present disclosure, ANPs can be optimized for various applications. For example, ANPs can be optimized for 800 nm emission, which can include a specific composition of ANP with 8% Thulium (Tm) as the dopant to get PA at 800 nm. Other exemplary compositions can be employed such as, for example, ANP with 100% doped Tm that can have a stronger emission at 700 nm than at 800 nm. According to further exemplary embodiments of the present disclosure, ANP design can be optimized for printing by, e.g., targeting UV emission at 360 nm. It is also possible to configure the chemistry of the resin that can properly accommodate ANP, and create a stable and uniform solution.

Further, according to various exemplary embodiments of the present disclosure, ANP can be uniformly mixed into a photoresin material, so that with each bit of material dispensed for a print job, there can be the right amount of ANP preferred for the print to achieve an ultra-high resolution. It is also possible to implement different ligands to bond ANPs to different photo-polymers to keep ANPs evenly dispersed within the polymer over a long period of time.

According to additional exemplary embodiments of the present disclosure, it is possible to provide a physical printer which can utilize AMPs embedded in the photoactivatable materials. For example, an exemplary laser can be sent to a pair of galvo mirrors for scanning. The light can be directed into an objective and focused onto a substrate where the photoresin is, and the voxels where the mirrors can scan over crosslinks and harden. In additional exemplary embodiments of the present disclosure, competing interests, such as scanning speed, resolution, and reproducibility may be considered and balanced. It is also possible to incorporate or utilize a software component including an interface between the user and the printer.

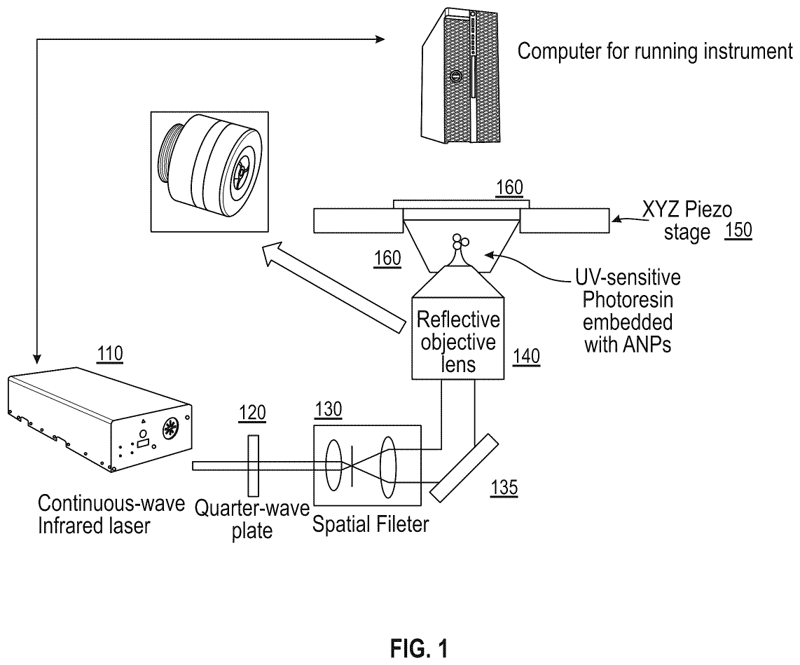

FIG. 1 shows a multiphoton lithography system facilitated by avalanching nanoparticles according to an exemplary embodiment of the present disclosure. As illustrated in FIG. 1, a continuous wave infrared laser 110 can be used to generate the light or other electro-magnetic radiation, which is forwarded via a quarter-wave plate 120 and a spatial filter 130 to an objective (e.g., a reflective objective lens 140) to focus the light/radiation, e.g., possible via one or more mirrors 135. The reflective objective lens 140 can be or include, e.g., ThorLabs LLMM40X-P01, although numerous other optical arrangement can be employed within the scope of the present disclosure. The focused radiation can be provided to a piezoelectric stage and/or galvo mirrors 150 that can move a focused laser beam in any of the x, y, z directions with nanoscale precision. The focused radiation can be provide through photo resin 160 (e.g., polymers, such as, epoxy) embedded with ANPs, as described herein.

In an exemplary system and/or operation according to the exemplary embodiments of the present disclosure, e.g., using an exemplary 3D printer design, the continuous wave infrared laser 110 can be excited and directed into a set of two or more Galvo mirrors 150. These galvo mirrors can rotate in x, y directions respectively, and thus, they can direct the light/radiation into any voxel inside the patternable media. The light/radiation can then be passed through the objective 140, which can focus the light/radiation into a much tighter spot. The speed of printing can be determined by the motor speed of the galvo rotating mirrors, and the NA of the objective. When the light/radiation exits the objective 140, it then can enter a bath of media (e.g., resin, spin-on glass, hydrogel) doped with ANPs 160. Upon exciting an ANP, blue/UVA photons can be produced and emitted locally, and that can cross link the polymers within, e.g., about 10s of nm in its vicinity. The material can then be hardened, and when the printing process is completed, the printed object can be ready.

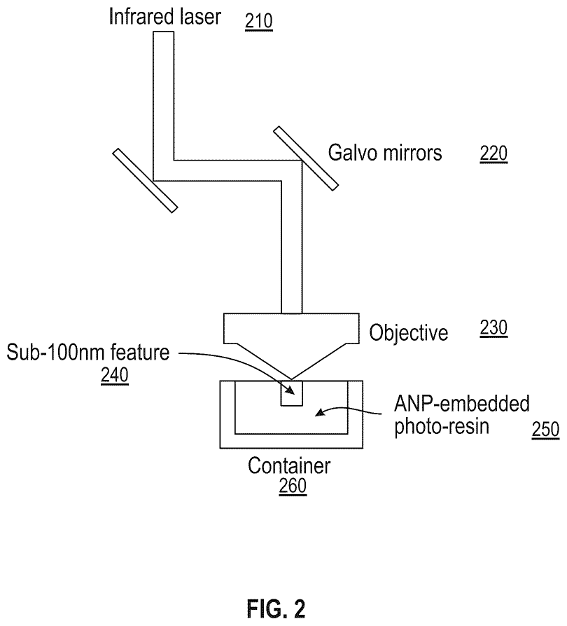

FIG. 2 shows the multiphoton lithography system facilitated by the avalanching nanoparticles according to another exemplary embodiments of the present disclosure which provides an exemplary 3D printing process according to exemplary embodiments of the present disclosure. The exemplary process starts with an infrared laser 210 for the crosslinking of the polymer solution. The laser is directed through a couple of galvo mirrors 210 which can direct the laser (e.g., the lasers described herein that are provided for the ANPs) into precise locations within the polymer 250. The objective 230 can concentrate the laser light into a focused beam. Below the optical setup, a bath of ANP-embedded photo-resin polymer 250 can be provided in a container 260. When the infrared laser 210 irradiates the beam in a desired spot within the polymer 250 bath, such portion of the bath becomes cross-link and solidifies. According to exemplary embodiments, as illustrated in FIG. 2, the infrared photons are locally converted to UV by the ANPs in the polymer 250, thus solidifying a section of the bath that is sub-100 nm in terms of feature size 240. This ultra-high resolution is not achieved by any other 3d printing method.

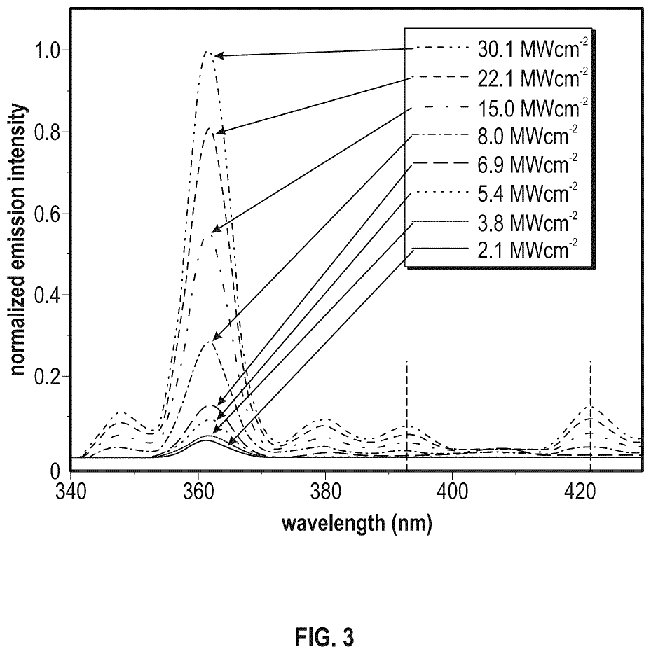

FIG. 3 shows an exemplary graph with various emissions, and indicating where the UV part of the spectrum is provided by ANPs when excited by, e.g., an infrared (IR) laser. In this exemplary case, the infrared laser can be at a wavelength of about 1064 nm. As shown in FIG. 3, with an increasing power density of the laser, the UV emission can also increase.

The photon-avalanche-induced multi-photon polymerization products and methods according to the exemplary embodiments of the present disclosure can provide significant benefits over the prior technology.

In particular, instead of a high-energy pulsed laser that may be needed for TPP, the exemplary technology according to the exemplary embodiments of the present disclosure only uses a continuous wave laser, which is orders of magnitude less expensive. Indeed, the components of the exemplary embodiments can also be smaller in terms of size, thus can make the printer more portable and take up less real estate on a table top.

In addition, higher number of photons can indicate a higher nonlinearity, thus, e.g., a sub-100 nm resolution can be achieved using the exemplary embodiments of the present disclosure. Further, traditional TPP process generally require post processing. In fact, after printing, a UV light is introduced to cure the printed structure. In contrast, using products, methods and systems according the exemplary embodiments of the present disclosure, since ANPs naturally emit in the UV, the structure can be cured while is being printed, and thus, it is possible to either eliminate or extensively reduce the post processing procedure that is utilized using the prior technologies.

Throughout the disclosure, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

In this description, numerous specific details have been set forth. It is to be understood, however, that implementations of the disclosed technology can be practiced without these specific details. In other instances, well-known methods, structures and techniques have not been shown in detail in order not to obscure an understanding of this description. References to “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one exemplary embodiment,” or “in one implementation” does not necessarily refer to the same example, exemplary embodiment, or implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the numbered claims.

### EXEMPLARY REFERENCES

The following references are hereby incorporated by reference, in their entireties:
1. Su, A. and S. J. Al'Aref, Chapter 1—History of 3D Printing, in 3D Printing Applications in Cardiovascular Medicine, S. J. Al'Aref, et al., Editors. 2018, Academic Press: Boston. p. 1-10.
2. Gonzalez-Hernandez, D., et al., Micro-Optics 3D Printed via Multi-Photon Laser Lithography. Advanced Optical Materials, 2023. 11(1): p. 2201701.
3. https://mitsloan.mit.edu/ideas-made-to-matter/additive-manufacturing-explained
4. https://www.mckinsey.com/capabilities/operations/our-insights/the-mainstreaming-of-additive-manufacturing

What is claimed is:

1. A product for three-dimensional (3D) printing, comprising:
a polymerizable photoactivated material; and
one or more avalanching nanoparticles (ANPs) embedded in the polymerizable photoactivated material.

2. The product of claim 1, wherein the polymerizable photoactivated material includes a resin.

3. The product of claim 1, wherein the polymerizable photoactivated material includes an epoxy.

4. The product of claim 1, wherein the polymerizable photoactivated material includes a liquid.

5. The product of claim 1, wherein the polymerizable photoactivated material includes a gel.

6. The product of claim 1, wherein the polymerizable photoactivated material includes a solution.

7. The product of claim 1, wherein a density of at least two of the one or more ANPs embedded in the polymerizable photoactivated material comprises a range from no space between adjacent ANPs to 100 microns between adjacent ones of the at least two of the one or more ANPs.

8. The product of claim 1, wherein the polymerizable photoactivated material is configured to cure a printed structure by the ultraviolet light emitted from the one or more ANPs.

9. The product of claim 1, wherein the polymerizable photoactivated material is configured to work with a laser emitting between 600 nm to 10 um.

10. A method for embedding one or more avalanching nanoparticles (ANPs) in a polymerizable photoactivated material, comprising:
mixing the polymerizable photoactivated material with a plurality of ANPs.

11. The method of claim 10, wherein the polymerizable photoactivated material includes a resin.

12. The method of claim 10, wherein the polymerizable photoactivated material includes an epoxy.

13. The method of claim 10, wherein the polymerizable photoactivated material includes a liquid.

14. The method of claim 10, wherein the polymerizable photoactivated material includes a gel.

15. The method of claim 10, wherein the polymerizable photoactivated material includes a solution.

16. A method of implementing one or more avalanching nanoparticles (ANPs) in three-dimensional (3D) printing, comprising:
directing a radiation from a continuous wave infrared laser to impact and activate the one or more ANPs embedded in a polymerizable photoactivated material.

17. The method of claim 10, wherein the radiation is provided to a stage on which the polymerizable photoactivated material is placed.

18. The method of claim 17, wherein the radiation may be directed to the stage having the polymerizable photoactivated material thereon in nanoscale precision.

19. The method of claim 18, wherein the nanoscale precision may be less than 100 nm.

20. The method of claim 18, wherein the nanoscale precision is at least 50 mn.

21. A system of implementing one or more avalanching nanoparticles (ANPs) in three-dimensional (3D) printing, comprising:
a source configuration configured to direct a radiation from a infrared laser to impact and activate the one or more ANPs embedded in a polymerizable photoactivated material from different sides of the polymerizable photoactivated material.

22. The system of claim 21, wherein the infrared laser is a continuous wave infrared laser.

23. The system of claim 21, wherein the different sides of the polymerizable photoactivated material impacted by the radiation are approximately opposite from one another.
